(19) United States
(12) Patent Application Publication
(10) Pub. No.: US 2017/0203423 A1
(43) Pub. Date: Jul. 20, 2017

(54) ASSEMBLY TOOL FOR THREAD INSERTS

(71) Applicant: Fairchild Fasteners Europe - Camloc GmbH, Kelkheim (Taunus) (DE)

(72) Inventor: Philipp Scholz, Olsbrücken (DE)

(73) Assignee: Fairchild Fasteners Europe - Camloc GmbH, Kelkheim (Taunus) (DE)

(21) Appl. No.: 15/410,209

(22) Filed: Jan. 19, 2017

(30) Foreign Application Priority Data
Jan. 20, 2016 (DE) 10 2016 100 933.4

(51) Int. Cl. B25B 27/14

(52) U.S. Cl. CPC B25B 27/143

(57) ABSTRACT

An assembly tool for thread inserts includes a stem, a bush, and a locking means. The stem includes a first external thread extending over at least a portion of the stem and a second thread extending over at least a portion of the stem. The bush includes a thread that is engaged with the second thread of the stem. The locking means releasably locks a rotation of the stem relative to the bush. A length of the stem and a length of the bush complement one another such that the first external thread of the stem protrudes at least partially from the bush.

### CROSS-REFERENCE TO RELATED APPLICATIONS

This application is a Section 119 application relating to and claiming the benefit of commonly owned, co-pending German Patent Application No. 10 2016 100 933.4, titled “ASSEMBLY TOOL, ITS APPLICATION AND METHOD FOR MOUNTING A THREAD INSERT,” having a filing date of Jan. 20, 2016, the contents of which are incorporated by reference herein in their entirety.

### FIELD OF THE INVENTION

The present invention relates to assembly tools for thread inserts and methods for using such tools to secure a thread insert in a workpiece.

### BACKGROUND OF THE INVENTION

Thread inserts are used in workpieces with low mechanical load capability (e.g., aluminum or gray cast iron components) to be able to subject the thread to comparatively higher loads. Such types of thread inserts are also suitable for repairing damaged threads. Thread inserts can be designed as a threaded bushing or as a threaded liner, and may include an external thread, so that they can be screwed into a component with a potentially damaged thread, and an internal thread or a stud with an external thread for connection with another component.

To securely fit thread inserts into a potentially damaged thread or into a potentially softer material, wedges or studs may be driven into the thread insert and/or into the workpiece that accommodates the thread insert. This particularly prevents the thread insert from twisting in the workpiece.

According to prior techniques, thread inserts are initially manually screwed into a workpiece using one to two rotations. Thereafter, the wedges or studs are inserted into grooves or holes of a tool and are engaged with the thread insert such that by a rotational movement of the tool, the thread insert can be screwed further into the workpiece by means of the wedges or studs. As soon as the wedges or studs encounter a facet during the hole preparation stage of the workpiece, the tool is removed and the wedges or studs are fastened, particularly if the wedges or studs are guided in holes of the workpiece. In a subsequent step, the tool is turned around or shifted, so that the wedges or studs can be driven into the tool by impacts with a hammer, until the tool strikes the workpiece surface. A cylindrical pin can be inserted into the internal thread of the thread insert to guide the tool relative to the thread insert.

As disclosed in DE 20 2015 106 393 U, an assembly tool comprises a bolt having at least some sections which are provided with a thread. The assembly tool also comprises an impact sleeve, within which the bolt is placed in a manner such that the bolt is axially movable with respect to the impact sleeve but cannot rotate with respect to the impact sleeve. The bolt (setscrew) is accommodated in the impact sleeve such that the bolt can immerse into the impact sleeve or can protrude from the impact sleeve, but without permitting appreciable twisting of the bolt relative to the impact sleeve.

Because of the consecutive steps of screwing in the thread insert and driving in the wedges or studs, this tool is suitable rather for manual assembly and for small runs.

### SUMMARY OF THE INVENTION

In an embodiment, an assembly tool for thread inserts includes a stem, a bush, and a locking means. In an embodiment, the stem includes a first external thread extending over at least a portion of the stem and a second thread extending over at least a portion of the stem. In an embodiment, the bush includes a thread that is engaged with the second thread of the stem. In an embodiment, the locking means provides for releasable locking of a rotation of the stem relative to the bush about a longitudinal axis of the assembly tool. In an embodiment, a length of the stem and a length of the bush complement one another such that the first external thread of the stem protrudes at least partially from the bush.

In an embodiment, the stem includes a stop, the bush includes a counterstop, and the locking means includes the stop of the stem and the counterstop of the bush, which cooperate to releasably lock a rotation of the stem relative to the bush about the longitudinal axis of the assembly tool when the stop of the stem bears against the counterstop of the bush.

In an embodiment, the assembly tool also includes a plunger having a first end that is supported by the bush and a second end opposite the first end. In an embodiment, the second end has a front wall facing away from the bush. In an embodiment, the plunger is positioned radially around the stem. In an embodiment, the plunger has a length such that the first external thread of the stem protrudes at least partially from the plunger. In an embodiment, the plunger is supported by the bush in a manner such that the plunger is freely rotatable relative to the bush about the longitudinal axis of the assembly tool but is not axially movable relative to the bush along the longitudinal axis of the assembly tool.

In an embodiment, the assembly tool also includes a spacer ring surrounding at least a portion of the stem and coupled to the stem in a manner such that the stem and the spacer ring are prevented from rotating with respect to one another about the longitudinal axis of the assembly tool. In an embodiment, the stem and the spacer ring are axially movable relative to the bush along the longitudinal axis of the assembly tool. In an embodiment, the spacer ring is axially movable relative to the plunger along the longitudinal axis of the assembly tool. In an embodiment, the assembly tool also includes an adjusting collar surrounding at least a portion of the stem and having an internal thread. In an embodiment, the spacer ring has an external thread that is engaged with the internal thread of the adjusting collar.

In an embodiment, the bush includes a first cylindrical section, a second cylindrical section, and a radially inwardly projecting flange positioned intermediate the first and second cylindrical sections. In an embodiment, the thread of the bush is an internal thread positioned within the first cylindrical section of the bush. In an embodiment, the stem includes a first end, a second end opposite the first end of the stem, and a shaft extending from the first end of the stem to the second end of the stem. In an embodiment, the first external thread of the stem is positioned on the first end of the stem. In an embodiment, the second thread of the stem is an external thread positioned on the second end of the stem. In an embodiment, a diameter of the second end of the stem is greater than a diameter of the first end of the stem. In an embodiment, the plunger includes a flange section secured within the second cylindrical section of the bush in a manner such that the flange section of the plunger is capable of pivoting with respect to the bush about the longitudinal axis of the assembly tool but is prevented from moving axially with respect to the bush along the longitudinal axis of the assembly tool. In an embodiment, the plunger encompasses the shaft of the stem. In an embodiment, the plunger includes two oblong holes. In an embodiment, a side of the plunger facing away from the bush includes a front wall having a chamfer. In an embodiment, a stud passes through the two oblong holes of the plunger and the spacer ring such that the spacer ring is prevented from rotating with respect to the plunger about the longitudinal axis of the assembly tool and is allowed to axially move with respect to the plunger along the longitudinal axis of the assembly tool. In an embodiment, each of the bush and the stem includes gripping means for a torque transfer tool.

In an embodiment, a spacer ring surrounds at least a portion of the stem. In an embodiment, the stem is coupled to the spacer ring such that the stem and the spacer ring are prevented from rotating with respect to one another about the longitudinal axis of the assembly tool. In an embodiment, the stem and the spacer ring are axially movable relative to the bush along the longitudinal axis of the assembly tool.

In an embodiment, a system includes an assembly tool and a thread insert. In an embodiment, the assembly tool includes a stem, a bush, and a locking means. In an embodiment, the stem includes a first external thread extending over at least a portion of the stem and a second thread extending over at least a portion of the stem. In an embodiment, the bush includes a thread that is engaged with the second thread of the stem. In an embodiment, the locking means provides for releasable locking of a rotation of the stem relative to the bush about a longitudinal axis of the assembly tool. In an embodiment, a length of the stem and a length of the bush complement one another such that the first external thread of the stem protrudes at least partially from the bush. In an embodiment, the thread insert includes a bush having an exterior surface including an external thread, an internal thread, at least one longitudinal groove formed in the exterior surface, and a stud positioned within the at least one longitudinal groove. In an embodiment, the internal thread of the thread insert is adapted to threadedly engage the first external thread of the stud of the assembly tool. In an embodiment, a radial position of the stud is matched to a radial position of the front wall of the plunger of the assembly tool.

In an embodiment, the stem of the assembly tool includes a stop. In an embodiment, the bush of the assembly tool includes a counterstop. In an embodiment, the locking means of the assembly tool includes the stop of the stem of the assembly tool and the counterstop of the bush of the assembly tool, which cooperate to releasably lock a rotation of the stem of the assembly tool relative to the bush of the assembly tool about the longitudinal axis of the assembly tool if the stop of the stem of the assembly tool bears against the counterstop of the bush of the assembly tool.

In an embodiment, the assembly tool also includes a plunger having a first end that is supported by the bush of the assembly tool and a second end opposite the first end. In an embodiment, the second end has a front wall facing away from the bush of the assembly tool. In an embodiment, the plunger is positioned radially around the stem of the assembly tool and has a length such that the first external thread of the stem of the assembly tool protrudes at least partially from the plunger. In an embodiment, the plunger of the assembly tool is supported by the bush of the assembly tool in a manner such that the plunger of the assembly tool is freely rotatable relative to the bush of the assembly tool about the longitudinal axis of the assembly tool but is not axially movable relative to the bush of the assembly tool along the longitudinal axis of the assembly tool. In an embodiment, the assembly tool also includes a spacer ring surrounding at least a portion of the stem of the assembly tool and coupled to the stem of the assembly tool in a manner such that the stem of the assembly tool and the spacer ring are prevented from rotating with respect to one another about the longitudinal axis of the assembly tool. In an embodiment, the stem of the assembly tool and the spacer ring are axially movable relative to the bush of the assembly tool along the longitudinal axis of the assembly tool. In an embodiment, the spacer ring of the assembly tool is axially movable relative to the plunger of the assembly tool along the longitudinal axis of the assembly tool. In an embodiment, the assembly tool also includes an adjusting collar surrounding at least a portion of the stem of the assembly tool and having an internal thread. In an embodiment, the spacer ring of the assembly tool has an external thread that is engaged with the internal thread of the adjusting collar.

In an embodiment, the bush of the assembly tool includes a first cylindrical section, a second cylindrical section, and a radially inwardly projecting flange positioned intermediate the first and second cylindrical sections. In an embodiment, the thread of the bush of the assembly tool is an internal thread positioned within the first cylindrical section of the bush of the assembly tool. In an embodiment, the stem of the assembly tool includes a first end, a second end opposite the first end of the stem of the assembly tool, and a shaft extending from the first end of the stem of the assembly tool to the second end of the stem of the assembly tool. In an embodiment, the first external thread of the stem of the assembly tool is positioned on the first end of the stem of the assembly tool. In an embodiment, the second thread of the stem of the assembly tool is an external thread positioned on the second end of the stem of the assembly tool. In an embodiment, a diameter of the second end of the stem of the assembly tool is greater than a diameter of the first end of the stem of the assembly tool. In an embodiment, the plunger of the assembly tool includes a flange section secured within the second cylindrical section of the bush of the assembly tool in a manner such that the flange section of the plunger of the assembly tool is capable of pivoting with respect to the bush of the assembly tool about the longitudinal axis of the assembly tool but is prevented from moving axially with respect to the bush of the assembly tool along the longitudinal axis of the assembly tool. In an embodiment, the plunger of the assembly tool encompasses the shaft of the stem of the assembly tool. In an embodiment, the plunger of the assembly tool includes two oblong holes. In an embodiment, a side of the plunger of the assembly tool facing away from the bush includes a front wall having a chamfer. In an embodiment, a stud passes through the two oblong holes of the plunger of the assembly tool and the spacer ring of the assembly tool such that the spacer ring of the assembly tool is prevented from rotating with respect to the plunger of the assembly tool about the longitudinal axis of the assembly tool and is allowed to axially move with respect to the plunger of the assembly tool along the longitudinal axis of the assembly tool. In an embodiment, each of the bush of the assembly tool and the stem of the assembly tool includes gripping means for a torque transfer tool.

In an embodiment, a method for mounting a thread insert in an opening of a workpiece includes providing an assembly tool including a stem, a bush, locking means, a plunger, and a spacer ring. In an embodiment, the stem includes a first external thread extending over at least a portion of the stem and a second thread extending over at least a portion of the stem. In an embodiment, the bush includes a thread that is engaged with the second thread of the stem. In an embodiment, the locking means provides for releasable locking of a rotation of the stem relative to the bush about a longitudinal axis of the assembly tool. In an embodiment, the plunger is supported by the bush. In an embodiment, the spacer ring surrounds at least a portion of the stem and is coupled to the stem, wherein a length of the stem and a length of the bush complement one another such that the first external thread of the stem protrudes at least partially from the bush. In an embodiment, the method also includes providing a thread insert. In an embodiment, the thread insert includes a bush having an exterior surface, an external thread formed in the exterior surface and complementary to the opening of the workpiece, an internal thread that is complementary to the first external thread of the stem of the assembly tool, at least one longitudinal groove in the exterior surface, and a stud positioned in each of the at least one longitudinal groove such that the stud does not extend completely along the external thread of the thread insert. In an embodiment, the method also includes threadedly engaging the internal thread of the thread insert to the first external thread of the stem while the locking means of the assembly tool locks the rotation of the stem of the assembly tool relative to the bush of the assembly tool about the longitudinal axis of the assembly tool. In an embodiment, the method also includes threadedly engaging the external thread of the thread insert to the opening of the workpiece by a rotation of the bush together with the stem about the longitudinal axis of the assembly tool in a first direction while the locking means of the assembly tool locks the rotation of the stem of the assembly tool relative to the bush of the assembly tool about the longitudinal axis of the assembly tool, until the assembly tool contacts the workpiece. In an embodiment, the method also includes configuring the locking means of the assembly tool such that the locking means of the assembly tool allows rotation of the stem of the assembly tool relative to the bush of the assembly tool about the longitudinal axis of the assembly tool. In an embodiment, the method also includes anchoring the thread insert in the opening of the workpiece by a rotation of the bush about the longitudinal axis of the assembly tool in the first direction relative to the stem, whereby the bush and the plunger move axially relative to the stem along the longitudinal axis of the assembly tool such that the rotation of the bush in the first direction relative to the stem causes the plunger to drive the stud into the at least one groove of the thread insert.

In an embodiment, the method also includes the step of removing the assembly tool from the thread insert by rotating the bush about the longitudinal axis of the assembly tool in a second direction that is opposite the first direction. In an embodiment, the step of threadedly engaging the external thread of the thread insert to the opening of the workpiece includes threadedly engaging the external thread of the thread insert to the opening of the workpiece by a rotation of the bush together with the stem about the longitudinal axis of the assembly tool in a first direction while the locking means of the assembly tool locks the rotation of the stem of the assembly tool relative to the bush of the assembly tool about the longitudinal axis of the assembly tool, until the spacer ring of the assembly tool contacts the workpiece.

In an embodiment, the assembly tool also includes an adjusting collar adjustably connected to the spacer ring. In an embodiment, the method also includes the step of adjusting a position of the adjusting collar relative to the spacer ring prior to threadedly engaging the internal thread of the thread insert to the first external thread of the stem. In an embodiment, the step of threadedly engaging the external thread of the thread insert to the opening of the workpiece includes threadedly engaging the external thread of the thread insert to the opening of the workpiece by a rotation of the bush together with the stem about the longitudinal axis of the assembly tool in a first direction while the locking means of the assembly tool locks the rotation of the stem of the assembly tool relative to the bush of the assembly tool about the longitudinal axis of the assembly tool, until the adjusting collar of the assembly tool contacts the workpiece.

### BRIEF DESCRIPTION OF THE DRAWINGS

FIG. 1 is a is an exploded view of components of a first embodiment of an exemplary assembly tool;

FIG. 2 is a side sectional view of the assembly tool of FIG. 1;

FIG. 3 is a top perspective view of the assembly tool of FIG. 1;

FIG. 4 is a bottom perspective view of the assembly tool of FIG. 1;

FIG. 5 is a side elevational view of the assembly tool of FIG. 1;

FIG. 6A is a side elevational view of the assembly tool of FIG. 1 and an exemplary thread insert at a first stage of an assembly process;

FIG. 6B is a side elevational view of the assembly tool and thread insert of FIG. 6A and a workpiece at a second stage of the assembly process;

FIG. 6C is a side elevational view of the assembly tool, thread insert, and workpiece of FIG. 6B at a third stage of the assembly process;

FIG. 6D is a side elevational view of the assembly tool, thread insert, and workpiece of FIG. 6B at a fourth stage of the assembly process;

FIG. 6E is a side elevational view of the assembly tool, thread insert, and workpiece of FIG. 6B at a fifth stage of the assembly process;

FIG. 6F is a side elevational view of the assembly tool, thread insert, and workpiece of FIG. 6B at a sixth stage of the assembly process;

FIG. 7A is a magnified sectional view of portions of the assembly tool, thread insert, and workpiece as shown in FIG. 6C;

FIG. 7B is a magnified sectional view of portions of the assembly tool, thread insert, and workpiece as shown in FIG. 6D; and

FIG. 8 is a side sectional view of a second embodiment of an assembly tool.

### DETAILED DESCRIPTION OF THE DRAWINGS

In an embodiment, an assembly tool has a stem, which is provided with first section having a first external thread and a second section having a second thread, a bush, which has a thread that is engaged with the second thread of the stem, and locking means for releasably locking rotation of the stem relative to the bush. In an embodiment, the length of the stem and the length of the bush are matched to one another such that the first external thread protrudes from the bush at least partially. In an embodiment, both the step of screwing the thread insert into a workpiece and the subsequent step of driving in of studs or wedges of the thread insert are accomplished by a rotation of the assembly tool. Accordingly, the assembly steps may be carried out by a continuous rotation of the assembly tool, such as a cordless screwdriver or the like, without having to use an additional tool, such as a hammer. Not having to change tools, particularly in large-scale production, saves lots of time and results in greater efficiency. The thread insert assembly can moreover be automated. A further advantage is that driving in the studs or wedges does not occur abruptly, so that damage to studs or wedges can largely be ruled out.

In an embodiment, the stem and the bush can be co-rotated (i.e., rotate together) in a first step of the thread insert assembly. For this purpose, locking means are provided, which make it more difficult for a relative rotation between the stem and the bush to occur at least to the extent that during an application of a relatively low torque, such as is required for screwing the thread insert into the workpiece, no relative movement occurs between the bush and the stem. On the other hand, if a higher torque is applied, a relative movement between the bush and the stem is permitted, wherein the relative axial movement, which is caused by the threaded engagement between the bush and the stem, is utilized for driving in studs or wedges. The locking means required for switching between the two operating modes of the assembly tool (i.e. on the one hand, the mode in which the bush and the stem rotate together for screwing in the insert and, on the other hand, the mode in which the bush and the stem rotate relative to one another driving in the studs or wedges) can either be designed such that the relative rotational movement between the bush and the stem (for example, in the manner of a pawl or ratchet or by means of interlocking) is completely blocked, or, alternatively, such that the relative rotational movement is inhibited to the extent that a relative rotation between the bush and the stem is prevented in any case when a comparatively low torque (e.g., the torque required for screwing the thread insert into the workpiece) is applied. In an embodiment, a friction coupling can be inserted between the bush and the stem. In another embodiment, the friction between the bush and the stem is increased without using additional components. To achieve this, the fitting between the bush and the stem can be selected accordingly and/or the friction coefficients of the bush and/or the stem can be selected accordingly. The locking means can therefore also be formed by the areas of the stem and of the bush that are in contact with each other.

In an embodiment, the stem has a thread on two sections, i.e., the first external thread for connection with the thread insert and a second thread that engages the bush. In an embodiment, the second thread of the stem is also an external thread that will engage with an internal thread of the bush. In an embodiment, the first external thread and the second thread of the stem can be designed as separated thread sections. In another embodiment, the stem includes a continuous thread, which forms both thread sections. In an embodiment, intersecting thread sections are provided on the stem. In an embodiment, both thread sections of the stem have the same direction of rotation. In an embodiment, the first external thread and the second thread of the stem have the same pitch. In an embodiment, the first external thread and the second thread of the stem have a different pitch.

In an embodiment, the locking means includes a stop of the stem and a counterstop of the bush, which will releasably lock a rotation of the stem relative to the bush if the stop bears against the counterstop. This can be achieved, for example, in that the stem and the bush, when threadedly engaged with one another, interlock if the stop of the stem contacts the counterstop of the bush, wherein this interlocking disconnects automatically if a greater torque is applied, as is required for driving in the wedges or studs.

In an embodiment, the bush, which turns both during screwing in of the thread insert into the workpiece as well as during the driving in of the studs and wedges, does not bear directly against studs and wedges which are not co-rotating in order to prevent damage as a result of this relative rotation. In an embodiment, the side of the bush facing the insert can be provided with a friction reducing coating so as to act as a sliding bearing. In an embodiment, the bush and the insert can be designed with a correspondingly low-friction mating of materials. In an embodiment, a plunger is supported on or in the bush, and is arranged radially outside of the stem. In an embodiment, the plunger has a front wall on the side facing away from the bush. The front wall of the plunger can be used for driving in wedges or studs, if the bush co-rotates with the plunger relative to the stem. In order to prevent interference during the step of screwing the stem into the thread insert, the length of the plunger, the length of the stem and the length of the bush may be matched to one another such that the first external thread of the stem projects at least partially from the bush and from the plunger. In an embodiment, the plunger is freely rotatable relative to the bush and is supported in or on the bush such that it is not axially movable relative to the bush. In an embodiment, the plunger is attached to the bush by using a needle or ball bearing and optionally a retaining ring, for example.

To switch over between the two assembly tool operating modes (i.e. the first mode, in which the bush and the stem rotate together, and the second mode, in which the bush rotates relative to the stem), the stem can be coupled with a spacer ring that surrounds it at least in sections, which rotates together with the stem, and which can be moved together with the stem axially relative to the bush for driving in the studs or wedges. For this purpose, the spacer ring moves jointly with the rest of the components of the assembly tool and together with the thread insert towards the workpiece while the thread insert is being screwed into the workpiece. As soon as the spacer ring strikes the workpiece surface with its front facing away from the bush, the required torque for rotating the assembly tool will increase, as a result. This torque increase causes a release of the locking means between the bush and the stem (i.e., causes the frictional forces between the bush and the stem to exceed a threshold of the locking means), as a result of which the bush will rotate relative to the fixed stem and the spacer ring, if the rotation of the bush is continued. Due to the threaded engagement between the stem and the bush, this results in the required relative axial movement between the stem and the bush or the plunger in order to move the studs or wedges relative to the thread insert. In an embodiment, the spacer ring is also axially movable relative to the plunger. In such an embodiment, the spacer ring may be secured in the stem by means of a stud, wherein the plunger is provided with oblong holes in which the stud is guided.

By using the spacer ring, the thread engagement length in the workpiece can be defined very accurately, since the screwing in of the thread insert is discontinued when the spacer ring strikes the workpiece surface (i.e., which causes the attachment tool to switch from the first to the second mode of operation), and the thread insert is subsequently fixed in its position relative to the workpiece by driving in the wedges or studs. As a result, a large number of thread inserts can be installed very accurately into a defined thread engagement length in the workpiece.

In an embodiment, when different thread engagement lengths are to be realized, the spacer ring can be designed replaceably, wherein different thread engagement lengths can be represented by using different dimensions of the spacer ring. In another embodiment, the spacer ring can have an adjustable design. In such an embodiment, the spacer ring can have a multipart design and have an external thread, for example, which engages with the internal thread of an adjusting collar which surrounds the stem at least in sections. The adjusting collar can be fixed in its position with a locknut, which also engages with the external thread of the spacer ring. In this case, the thread engagement of the thread insert is defined by a position of the adjusting collar relative to the spacer ring and therefore to the stem. For a reduced thread engagement length of the thread insert, the adjusting collar may be advanced relative to the direction of screwing in of the thread insert, so that the screwing in process is terminated earlier, whereas the adjusting collar may be retracted relative to the stem if a greater thread engagement length is to be obtained.

In an embodiment of an assembly tool, the bush has a first cylindrical section in which an internal thread is provided, and a second cylindrical section, which is spaced apart from the first section by a rib or flange projecting radially inward, and in which a flange section of the plunger is pivoted and secured against axial movement, e.g., by means of a retaining ring. The stem has a shaft, on the one end of which a first external thread is provided and on the opposite second end of which a second external thread is provided, the second end having an enlarged diameter compared to the shaft. The plunger encompasses the shaft of the stem and has two oblong holes, which may be used to couple the adjusting collar to the plunger by passing a stud through the adjusting collar and the oblong holes. When the plunger and the adjusting collar are coupled in this manner, the adjusting collar may move axially relative to the plunger, but the adjusting collar and plunger rotate together about the axis. In an embodiment, the bush and the stem are equipped with gripping means for a torque transfer tool. In an embodiment, the front wall of the face on the side of the plunger facing away from the bush is provided with a facet, so that the plunger can be matched to the geometry of the opening in the workpiece. In an embodiment, a shoulder is provided on the front wall of the plunger.

In another embodiment, the above-described assembly tool is attached to a thread insert which matches the assembly tool. In such an embodiment, the thread insert is designed as a bush with one external thread and one internal thread. At least one longitudinally extending groove is provided in the exterior surface of the thread insert. A wedge or stud is movably positioned within the groove. In such an embodiment, the internal thread of the thread insert is matched to the first external thread of the stem of the assembly tool, so that they can be screwed together. In an embodiment, the radial position of the at least one stud or wedge is matched to the radial position of the front wall of the plunger of the assembly tool, so that the plunger can drive in the at least one stud or wedge.

In another embodiment, a method for attaching a thread insert in an opening of a workpiece includes providing an assembly tool as described above and providing a thread insert. The thread insert is designed as a bush with one external thread and one internal thread. At least one groove extends longitudinally in the exterior surface of the thread insert, in which a stud or wedge is accommodated such that the stud or wedge does not completely extend along the external thread of the thread insert in the axial direction. Initially the stud or wedge does not block the external thread of the thread insert being screwed into the workpiece, but protrudes beyond the sleeve-like main body of the insert on the side facing away from the workpiece. The thread insert is screwed onto the first external thread of the stem, while the rotation of the stem is already inhibited or blocked relative to the bush. The thread insert is subsequently screwed into the opening of the workpiece by rotating the bush together with the stem, until the front wall of the spacer ring, or of an optional adjusting collar, strikes the workpiece. At this point, the lock or blockage between the bush and the stem is either released automatically, as described above, or by a defined procedure, such as by releasing a locking element or switching over of a pawl or ratchet. This thread insert is subsequently anchored in the opening of the workpiece by driving the stud or wedge into the groove by rotating the bush relative to the stem, the plunger and the spacer ring. As described above, this causes an axial relative movement between the bush and the plunger on the one side, and the fixed stem with the spacer ring, on the other.

In an embodiment, the bush is rotated by means of a motor-driven tool, for example by means of a drilling machine, by means of a cordless screwdriver or by means of a pneumatic screwdriver. Such tools can be equipped with an overload coupling, for example, with a friction coupling, which prevents the bush from being driven further after a maximum torque has been reached. This can be utilized to stop further driving in of the studs or wedges, once the plunger driven in the studs or wedges up to a point, for example, where they are essentially flush with the sleeve-like main body of the insert. Due to the contact of the bush or the plunger with the sleeve-like main body of the insert, the torque needed for the continued rotation of the bush abruptly increases. If the maximum torque that can be transferred by the overload coupling is appropriately selected, this increase can be utilized for a defined termination of the driving in operation.

Continuing to describe the above exemplary method, the assembly tool can be detached from the workpiece and from the thread insert. This may be accomplished by changing the rotational movement of the bush. In an embodiment, this will initially produce a relative movement between bush and stem, until the stem is interlocked again with the bush. In another embodiment, this can be achieved by actuating a locking element or a pawl or ratchet. Subsequently, the bush and the stem can again be co-rotated, so that the stem unscrews from the thread insert. The assembly tool is therefore again in the initial position.

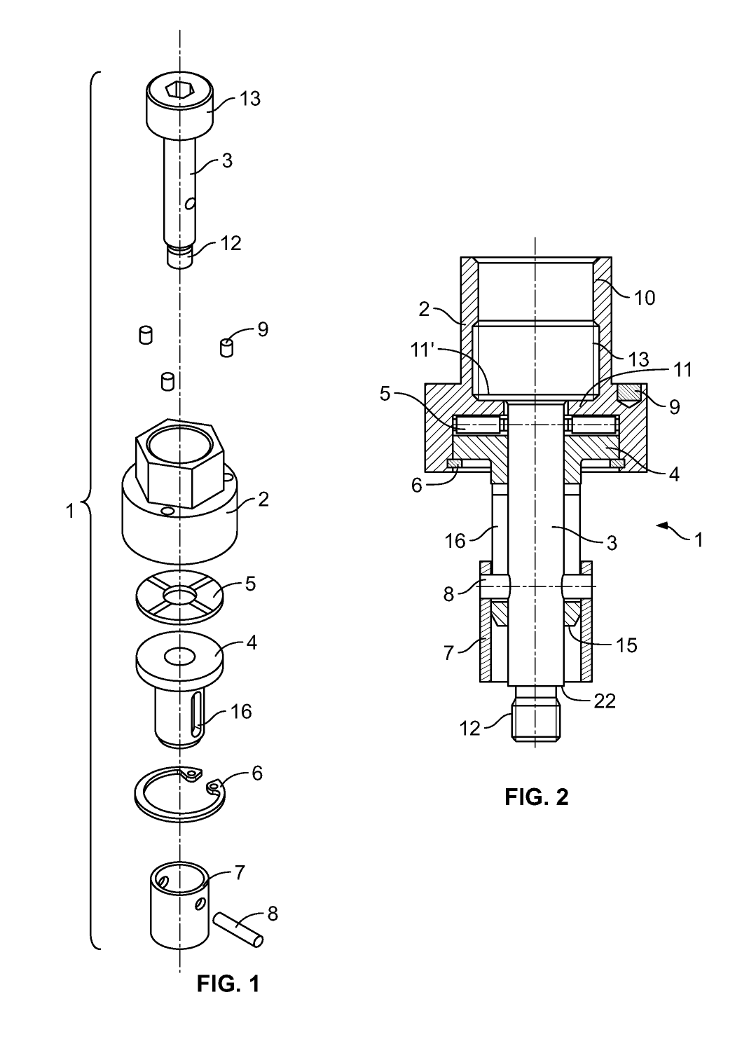

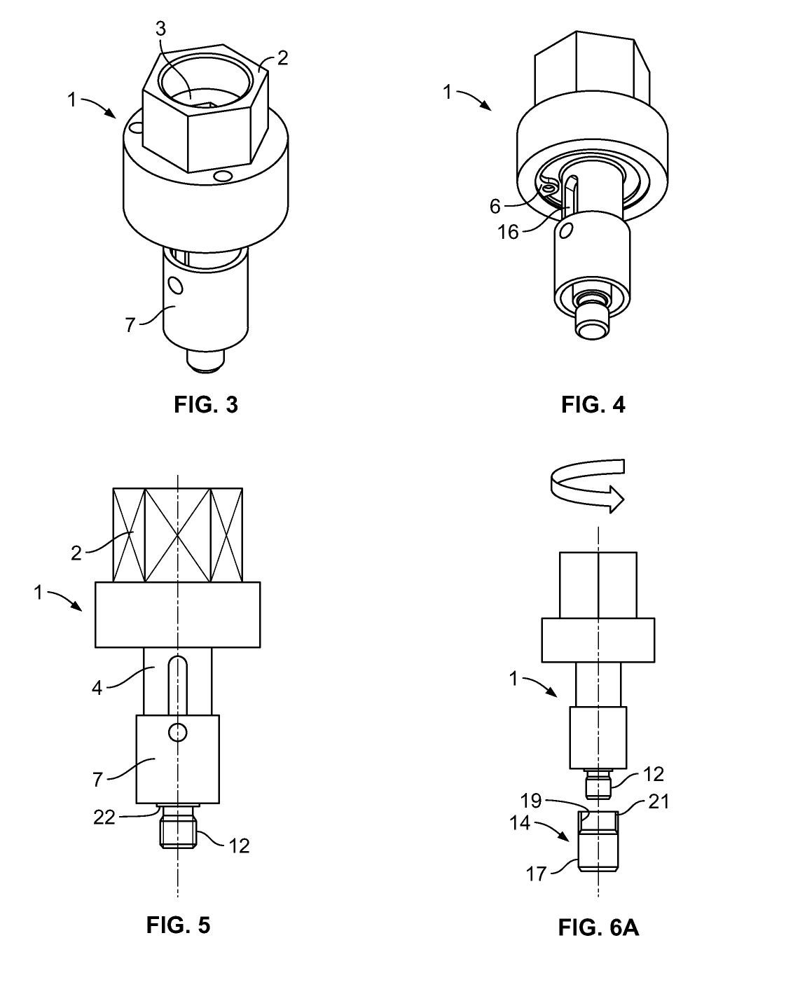

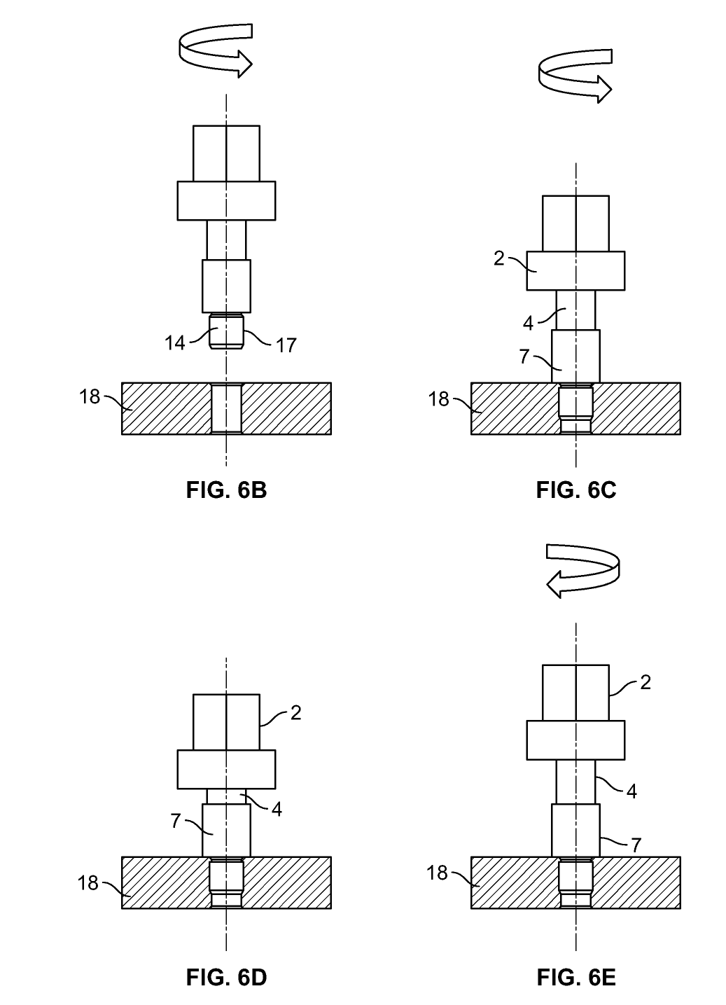

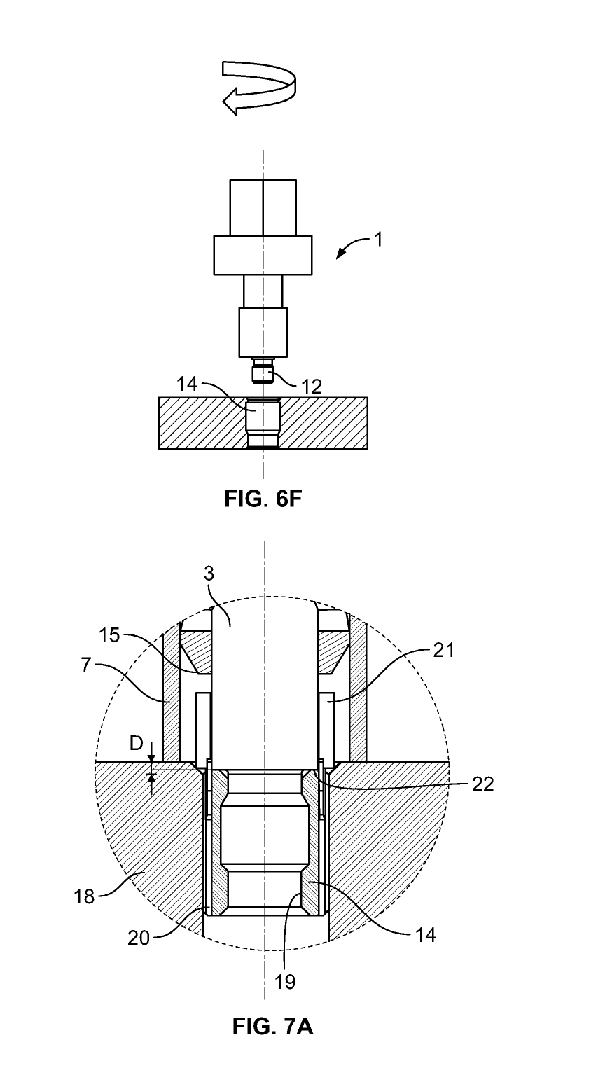

Referring now to FIGS. 1 through 7B, an embodiment of an assembly tool 1 is illustrated. The assembly tool 1 includes a bush 2, a stem 3, a plunger 4, a bearing 5, a retaining ring 6, a spacer ring 7, a stud 8, and a plurality of magnets 9. The assembly tool 1 will be described herein with reference to a longitudinal axis, along which elements of the assembly tool 1 may move and about which elements of the assembly tool 1 may rotate. Additionally, elements of the assembly tool 1 may be referred to herein as being “lower” or “below” if they are closer to a workpiece (see FIG. 6C) along the longitudinal axis, or “higher” or “above” if they are further away from the workpiece, and the portion of the assembly tool 1, or of an element of the assembly tool 1, that is closest to the workpiece may be referred to as the “front.”

Referring now to FIGS. 1 and 2, the bush 2 includes a lower cylindrical section, which forms a space for accommodating an area of the plunger 4, the bearing 5, and the retaining ring 6. An upper section of the bush 2 has a hexagonal outside profile, which provides gripping means for a torque-transmitting tool, like a wrench or a power-operated screwdriver. The interior of the upper section of the bush 2 defines an essentially cylindrical space, which is provided with an internal thread 10. The upper space and the lower space of the bush 2 are spaced apart by a flange 11 that projects radially to the inside and which has an opening for the stem 3. In the lower section of bush 2, three permanent magnets 9 are inserted, which make it possible for the assembly tool 1 to be magnetically fixed to a torque transfer tool.

Continuing to refer to FIGS. 1 and 2, the stem 3 has a cylindrical shaft, for example, which connects two externally threaded sections. The lower section of the stem 3 has a smaller external diameter compared with the shaft, and has a first exterior thread 12. The upper section of the stem 3 has a larger outside diameter (i.e., has a head-like shape) and has a second external thread 13. The upper area of the stem 3 is provided with a further gripping means for a torque transfer tool can be provided. For example, the upper area of the stem 3 may include a hexagonal recess, as illustrated in FIG. 1.

As described in greater detail below, the first external thread 12 of the stem 3 can be screwed into a thread insert 14 (see FIGS. 6A and 6B). The second external thread 13 of the stem 3 engages with the internal thread 10 of the bush 2. Referring now to FIG. 2, the stem 3 is screwed into the bush 2 until the shoulder between the shaft and the head of the stem 3 and of the head of the stem 3 bears against the flange 11 of the bush 2. When the stem 3 is so positioned, the lower side of the head of the stem 3 forms a stop 11′, which, together with the flange 11 acting as a counterstop, acts as locking means for releasably locking rotation of the stem 3 relative to the bush 2. In this position of the stem 3 in the bush 2, the stem 3 and the bush 2 are therefore interlocked, in the same manner as is a nut that is tightened to a great degree onto a threaded bolt. As a result, the bush 2 can only be rotated relative to the stem 3 if an applied torque surpasses this clamping effect. Due to the engagement of the second external thread 13 of the stem 3 with the internal thread 10 of the bush 2, a relative rotation of the bush 2 with respect to the stem 3 also produces a relative axial movement, as a result of which the stem 3 may move upward relative to the bush 2 (“upward” referring to the orientation of the assembly tool 1 as shown in FIGS. 1 and 2).

Continuing to refer to FIGS. 1 and 2, the plunger 4 is a sleeve-like component, the upper end of which has a flange. The plunger 4 encompasses the shaft of the stem 3 such that the stem 3 is movable in axial direction relative to the plunger 4. The flanged end of the plunger 4 is pivotably positioned in the lower area of the bush 2. The bearing 5 is provided between the bush 2 and the clamping component 4. In an embodiment, the bearing 5 is a needle bearing. The plunger 4 is held in the bush 2 by means of the retaining ring 6 such that the plunger 4 does not move axially relative to the bush 2. On its end facing away from the bush 2 (i.e., at the bottom of the clamping component 4 as shown in FIGS. 1 and 2) the clamping component 4 has a front wall 15. In an embodiment, the front wall 15 is stepped. In an embodiment, the front wall 15 is provided with a facet. In an embodiment, the front wall 15 is chamfered. The clamping component 4 also includes two opposing oblong holes 16, which extend in the longitudinal direction of the assembly tool 1.

Continuing to refer to FIGS. 1 and 2, the spacer ring 7 is likewise designed as an essentially sleeve-like component. The spacer ring 7 has an inside diameter that is slightly larger than the external diameter of the plunger 4, so that the spacer ring 7 encompasses the plunger 4, but is movable relative to same. A stud 8 attaches the spacer ring 7 to the plunger 4 and the stem 3, passing through the lateral openings of the spacer ring 7, the oblong holes 16 of the plunger 4 and a transverse opening in the shaft of the stem 3. As a result, the spacer ring 7 is connected to the stem 3 such that the spacer ring 7 is not movable axially or rotationally with respect to the stem 3. The spacer ring 7 is connected to the plunger 4 in a manner such that the spacer ring 7 is axially movable with respect to the plunger 4 but cannot rotate with respect to the plunger 4.

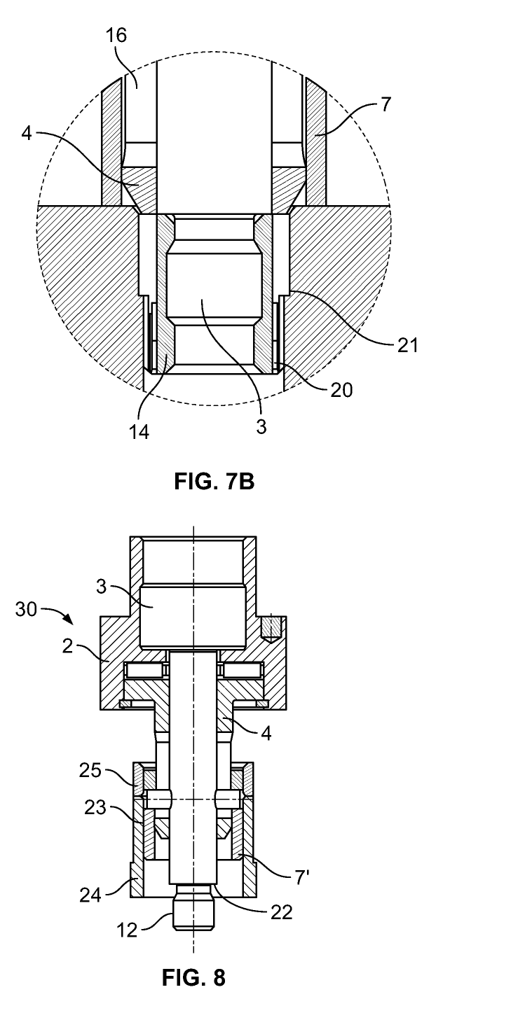

Referring now to FIGS. 6A and 7A, the thread insert 14 to be installed by the assembly tool 1 has a generally sleeve-like shape and has an external thread 17 for screwing into a threaded hole of a workpiece 18. The thread insert 14 also includes an internal thread 19, which is matched to the first external thread 12 of the stem 3. Grooves 20 are formed in the external cylindrical surface of the thread insert 14. The grooves 20 extend in the axial direction, i.e., in the longitudinal direction of the assembly tool. A stud or wedge 21 is positioned within each of the grooves 20, and is held by a clamping force in the groove 20. In another embodiment, the wedge 21 can be detachably connected with the thread insert 14 in another manner.

Prior to the assembly of the thread insert 14 (see FIGS. 6A and 7A), the wedges 21 are positioned rearward in the direction of screwing in, i.e., on the side of the thread insert 14 facing away from the workpiece 18 and above the main body of the thread insert 14. In such position, the wedges 21 do not overlap or only slightly overlap with the external thread of the thread insert 14, so that screwing the thread insert 14 into the workpiece 18 is not impeded by the wedges 21. In an embodiment, the thread insert 14 includes one wedge 21. In an embodiment, the thread insert 14 includes a plurality of wedges 21.

Referring now to FIGS. 6A through 7B, the use of the assembly tool 1 to mount a thread insert 14 into a workpiece 18 will be described. At the start of the assembly operation, the bush 2 and the stem 3 are positioned as shown in FIG. 2, i.e., the stem 3 is screwed into the bush 2 and is tightly wedged there such that a low torque can be transferred from the bush 2 to the stem 3, without them moving relative to one another. This position will be referred to herein as a first mode of operation. In another embodiment, the first mode of operation can also be achieved by providing an overload coupling between the bush 2 and the stem 3, which overload coupling permits relative twisting to the bush 2 and the stem 3, only when a defined torque is exceeded. In another embodiment, another suitable locking mechanism can be provided, which prevents relative twisting of the bush 2 and can be released.

Referring now to FIGS. 2 and 6A, in the initial position, the first external thread 12 of the stem 3 protrudes beyond the front wall of the spacer ring 7, which is facing the workpiece 18. The thread insert 14 can be connected with the assembly tool 1 by rotating the bush 2, which causes the stem 3 to co-rotate and causes the first external thread 12 of the stem 3 to threadedly engage the internal thread 19 of the thread insert 14. In this position, the wedges 21 project into the clearance between the spacer ring 7 and the shaft of the stem 3 (see FIG. 7A). In an embodiment, a shoulder 22 is formed at the junction between the shaft of the stem 3 and the first external thread 12. The thread insert 14 strikes the shoulder 22 when the thread insert 14 is screwed completely onto the stem 3.

Referring now to FIGS. 6B, 6C, and 7A, the assembly tool 1 with the thread insert 14 is taken to the workpiece 18 provided with the threaded hole. The thread insert 14 is screwed into the workpiece 18 by continuing to rotate the bush 2, as described above. The torque required for this step is comparatively small. Consequently, the clamp connection between the bush 2 and the stem 3 will not release, but, rather, the torque applied to the bush 2 is transmitted into the stem 3 and the thread insert 14. The position of the assembly tool 1, the thread insert 14, and the workpiece 18 after this step is shown in FIG. 6C.

The thread engagement length of the thread insert 14 within the workpiece can be defined via the axial extension of the spacer ring 7. Referring now to FIG. 7A, the thread engagement length of the thread insert 14 into the workpiece 18 is determined by an axial distance D between the shoulder 22 of the stem 3 and the front wall of the spacer ring 7 facing the workpiece 18. The thread insert 14 is completely screwed into the workpiece when the front wall of the spacer ring 7 contacts the surface of the workpiece 18. If the distance D between the shoulder 22 of the stem 3 and the front wall of the spacer ring 7 is greater (i.e., if the assembly tool 1 is provided with a spacer ring 7 that is smaller than the spacer ring shown in FIG. 7A), the thread insert 14 can be screwed into the workpiece 18 to a greater depth. In another embodiment, the thread insert 14 may be positioned flush with the surface of the workpiece 18 if the shoulder 22 of the stem 3 is flush with the front wall of the spacer ring 7 (i.e., if the distance D shown in FIG. 7A is zero). In another embodiment, the thread insert 14 may protrude beyond the surface of the workpiece 18, if the shoulder 22 of the stem 3 is offset upward with respect to the front wall of the spacer ring 7 (i.e., if the distance D shown in FIG. 7A is negative). The thread engagement length of the thread insert 14 may be adaptable to different requirements by providing spacer rings 7 having different lengths.

In another embodiment, the thread engagement length of the thread insert 14 may be limited when the wedges 21 strike against the workpiece 18. Continuing to refer to FIG. 7A, it may be seen that one edge of the wedges 21 strikes against a facet of the opening in the workpiece 18, if the front wall of the spacer ring 7 contacts the surface of the workpiece 18.

The contact between the front wall of the spacer ring 7 with the surface of the workpiece 18 (or the contact of the wedges 21 with the workpiece 18) causes the required torque for screwing in the thread insert 14 to increase abruptly, due to the continued advancement of the stem 3 with the thread insert 14 into the workpiece 18 while the spacer ring 7 (which is connected axially with the stem 3 by means of the stud 8) is pressed against the surface of the workpiece 18. This increase of the torque causes disengagement of the clamp connection between the bush 2 and the stem 3. In another embodiment, in which a friction coupling is provided between the bush 2 and the stem 3, the maximum torque that can be transmitted is adjusted, for example, so that the friction coupling will slip if the spacer ring 7 strikes the surface of the workpiece 18. In another embodiment, when the spacer ring 7 strikes the surface of the workpiece 18, a lock between the bush 2 and the stem 3 may be released manually or automatically. Because of this procedure, the assembly tool 1 is transferred into its second mode of operation, in which the bush 2 and the stem 3 are rotatable relative to one another.

Referring now to FIGS. 6D and 7B, continued rotation of the bush 2 when the assembly tool 1 is in the second mode of operation will produce a relative axial movement between the bush 2 and the stem 3. The spacer ring 7 is firmly axially connected with the stem 3 and, as a result, remains in the position shown in FIG. 7A. Because of the relative movement between the bush 2 and the stem 3, the plunger 4 (which is axially coupled to the bush 2) is also moved relative to the stem 3 (i.e., in the orientation shown in FIG. 2, towards the bottom). Consequently, the front wall 15 of the plunger 4 strikes against the side of the wedges 21 facing the assembly tool 1 (i.e., the top of the wedges 21, as shown in FIGS. 7A and 7B) and drives the wedges 21 further into the grooves 20 and into the workpiece 18 during continued rotation of the bush 2. As a result, the thread insert 14 is anchored in the workpiece 18 in a manner such that the wedges 21 prevent the thread insert 14 from rotating. The position of the assembly tool 1 after this step has been performed is shown in FIG. 6D; the position of the wedges 21 after this step has been performed is shown in FIG. 7B.

When the front wall 15 of the plunger 4 (or a facet attached thereto) makes contact with the surface of the workpiece 18, there is another significant increase in the torque. This second increase of the torque can be utilized for switching off a tool (e.g., an electric screwdriver) driving the assembly tool 1, for example by means of a friction coupling.

Next, the assembly tool 1 can be returned to its first mode of operation and can be unscrewed from the workpiece 18 and the thread insert 14. For this purpose, the rotation of the tool driving the bush 2 is reversed, as is indicated by the arrows shown in FIGS. 6E and 6F. Since the stem 3 and the spacer ring 7 above the thread insert 14 are at least slightly braced with the workpiece 18, when the direction of rotation of the bush 2 is reversed, initially a relative movement between the bush 2 and the stem 3 occurs until the stem 3 has reached its initial position with respect to the bush 2, as illustrated in FIG. 2. When the stud 3 strikes against the flange 11 of the bush 2, the two will again interlock, such that the stem 3 and the bush 2 are connected to one another in a rotation-proof manner (i.e., the assembly tool 1 is again in its first mode of operation).

In another embodiment, this return may occur by means of a locking mechanism that intervenes manually or automatically. Rotation of the bush 2 continues, causing the first external thread 12 of the stem 3 is to unscrew from the thread insert 14, whereby the assembly process is completely finalized, as shown in FIG. 6F.

FIG. 8 illustrates an embodiment of an assembly tool 30. The assembly tool 30 is substantially similar to the assembly tool 1 described above. For this reason, identical components are designated with identical reference symbols. The assembly tool 30 includes a spacer ring 7′ having an external thread 23. An adjusting collar 24 having an internal thread is screwed onto the external thread 23. A locknut 25 having an internal thread is also screwed onto the external thread 23. The adjusting collar 24 can be fixed in its position on the spacer ring 7′ by means of the locknut 25. If the locknut 25 is loosened, the position of the adjusting collar 24 relative to the spacer ring 7′ can be changed. In this way, the space between the shoulder 22 of the stem 3 and the front wall of the adjusting collar 24 facing the workpiece 18 (i.e., which is analogous to the distance D shown in FIG. 7A) is also changed. Therefore, the thread engagement length of a thread insert 14 into a workpiece 18 can be adjusted by a corresponding adjustment of the position of the adjusting collar 24 without replacing the spacer ring 7′.

In another embodiment, an assembly tool may lack a spacer ring. In such an embodiment, the assembly tool may be switched between the first and second modes of operation when the wedges 21 of the thread insert 14 strike the surface of the workpiece 18. The screwing in process in the first mode of operation can alternatively be terminated by stopping the bush 2. The clamp connection between the stem 3 and the bush 2 can then be released, in that the stem 3 is stopped at least briefly relative to the bush 2, which will then continue to rotate. For example, this may be accomplished via the gripping means in the head of the stem 3 (see FIG. 1). Correspondingly, the first mode of operation can be restored if the stem 3 and the bush 2 are reciprocally braced by engaging an appropriate tool.

In another embodiment, the bearing 5 may be omitted and the plunger 4 may be integrally formed with, or may be rotationally coupled to, the bush 2. In such an embodiment, when the wedges 21 are driven into the thread insert 14, the front wall 15 of the plunger 4 will rotate relative to the wedges 21. This may produce friction, which may result in damage to the wedges 21; such friction may be counteracted by employing an appropriate design of front wall 15, such as by using a coating. In such an embodiment, a spacer ring may be included or may be omitted.

Through the use of the exemplary assembly tool 1 or other exemplary assembly tools as described herein, the complete installation of the thread insert 14 may be accomplished using purely bi-directional rotational movement. The linear force for inserting the wedges 21 is produced by a rotational movement, which is converted to a linear movement by means of the inter-engaging threads 10 and 13. The exemplary assembly tool 1 is compatible with commercially known screwdrivers and wrenches. The installation depth can be adjusted very accurately, such that the load to the workpiece 18 is minimal. Installation of the thread insert 14 with the exemplary assembly tool 1 is ergonomic and quiet, since the use of a hammer to drive the wedges 21 into the thread insert 14 is not required. The assembly tool 1 also makes it possible to install the thread insert 14 even if the available overall height for installation is limited, and it is characterized by good accessibility in limited space.

It should be understood that the embodiments described herein are merely exemplary in nature and that a person skilled in the art may make many variations and modifications thereto without departing from the scope of the present invention. All such variations and modifications, including those discussed above, are intended to be included within the scope of the invention.

What is claimed is:

1. An assembly tool for thread inserts, the assembly tool comprising:
a stem including a first external thread extending over at least a portion of the stem and a second thread extending over at least a portion of the stem;
a bush including a thread that is engaged with the second thread of the stem; and
locking means for releasable locking of a rotation of the stem relative to the bush about a longitudinal axis of the assembly tool,
wherein a length of the stem and a length of the bush complement one another such that the first external thread of the stem protrudes at least partially from the bush.

2. The assembly tool of claim 1, wherein the stem includes a stop, wherein the bush includes a counterstop, and wherein the locking means includes the stop of the stem and the counterstop of the bush, which cooperate to releasably lock a rotation of the stem relative to the bush about the longitudinal axis of the assembly tool when the stop of the stem bears against the counterstop of the bush.

3. The assembly tool of claim 1, further comprising a plunger having a first end that is supported by the bush and a second end opposite the first end, the second end having a front wall facing away from the bush, the plunger being positioned radially around the stem, the plunger having a length such that the first external thread of the stem protrudes at least partially from the plunger.

4. The assembly tool of claim 3, wherein the plunger is supported by the bush in a manner such that the plunger is freely rotatable relative to the bush about the longitudinal axis of the assembly tool but is not axially movable relative to the bush along the longitudinal axis of the assembly tool.

5. The assembly tool of claim 3, further comprising a spacer ring surrounding at least a portion of the stem and coupled to the stem in a manner such that the stem and the spacer ring are prevented from rotating with respect to one another about the longitudinal axis of the assembly tool, wherein the stem and the spacer ring are axially movable relative to the bush along the longitudinal axis of the assembly tool.

6. The assembly tool of claim 5, wherein the spacer ring is axially movable relative to the plunger along the longitudinal axis of the assembly tool.

7. The assembly tool of claim 5, further comprising an adjusting collar surrounding at least a portion of the stem and having an internal thread, wherein the spacer ring has an external thread that is engaged with the internal thread of the adjusting collar.

8. The assembly tool of claim 5, wherein the bush includes a first cylindrical section, a second cylindrical section, and a radially inwardly projecting flange positioned intermediate the first and second cylindrical sections, wherein the thread of the bush is an internal thread positioned within the first cylindrical section of the bush,
wherein the stem includes a first end, a second end opposite the first end of the stem, and a shaft extending from the first end of the stem to the second end of the stem, wherein the first external thread of the stem is positioned on the first end of the stem, wherein the second thread of the stem is an external thread positioned on the second end of the stem, and wherein a diameter of the second end of the stem is greater than a diameter of the first end of the stem,
wherein the plunger includes a flange section secured within the second cylindrical section of the bush in a manner such that the flange section of the plunger is capable of pivoting with respect to the bush but is prevented from moving axially with respect to the bush, wherein the plunger encompasses the shaft of the stem, wherein the plunger includes two oblong holes, and wherein a side of the plunger facing away from the bush includes a front wall having a chamfer,
wherein a stud passes through the two oblong holes of the plunger and the spacer ring such that the spacer ring is prevented from rotating with respect to the plunger about the longitudinal axis of the assembly tool and is allowed to axially move with respect to the plunger along the longitudinal axis of the assembly tool, and
wherein each of the bush and the stem includes gripping means for a torque transfer tool.

9. The assembly tool of claim 1, further comprising a spacer ring surrounding at least a portion of the stem, the stem being coupled to the spacer ring such that the stem and the spacer ring are prevented from rotating with respect to one another about the longitudinal axis of the assembly tool, and wherein the stem and the spacer ring are axially movable relative to the bush along the longitudinal axis of the assembly tool.

10. A system, comprising:
an assembly tool including:
a stem including a first external thread extending over at least a portion of the stem and a second thread extending over at least a portion of the stem;
a bush including a thread that is engaged with the second thread of the stem; and
locking means for releasable locking of a rotation of the stem relative to the bush about a longitudinal axis of the assembly tool,
wherein a length of the stem and a length of the bush complement one another such that the first external thread of the stem protrudes at least partially from the bush; and
a thread insert including a bush having an exterior surface including an external thread, an internal thread, at least one longitudinal groove formed in the exterior surface, and a stud positioned within the at least one longitudinal groove, wherein the internal thread of the thread insert is adapted to threadedly engage the first external thread of the stud of the assembly tool, and wherein a radial position of the stud is matched to a radial position of the front wall of the plunger of the assembly tool.

11. The system of claim 10, wherein the stem of the assembly tool includes a stop, wherein the bush of the assembly tool includes a counterstop, and wherein the locking means of the assembly tool includes the stop of the stem of the assembly tool and the counterstop of the bush of the assembly tool, which cooperate to releasably lock a rotation of the stem of the assembly tool relative to the bush of the assembly tool about the longitudinal axis of the assembly tool if the stop of the stem of the assembly tool bears against the counterstop of the bush of the assembly tool.

12. The system of claim 10, wherein the assembly tool further comprises a plunger having a first end that is supported by the bush of the assembly tool and a second end opposite the first end, the second end having a front wall facing away from the bush of the assembly tool, the plunger being positioned radially around the stem of the assembly tool, the plunger having a length such that the first external thread of the stem of the assembly tool protrudes at least partially from the plunger.

13. The system of claim 12, wherein the plunger of the assembly tool is supported by the bush of the assembly tool in a manner such that the plunger of the assembly tool is freely rotatable relative to the bush of the assembly tool about the longitudinal axis of the assembly tool but is not axially movable relative to the bush of the assembly tool along the longitudinal axis of the assembly tool.

14. The system of claim 12, wherein the assembly tool further comprises a spacer ring surrounding at least a portion of the stem of the assembly tool and coupled to the stem of the assembly tool in a manner such that the stem of the assembly tool and the spacer ring are prevented from rotating with respect to one another about the longitudinal axis of the assembly tool, and wherein the stem of the assembly tool and the spacer ring are axially movable relative to the bush of the assembly tool along the longitudinal axis of the assembly tool.

15. The system of claim 14, wherein the spacer ring of the assembly tool is axially movable relative to the plunger of the assembly tool along the longitudinal axis of the assembly tool.

16. The system of claim 14, wherein the assembly tool further comprises an adjusting collar surrounding at least a portion of the stem of the assembly tool and having an internal thread, and wherein the spacer ring of the assembly tool has an external thread that is engaged with the internal thread of the adjusting collar.

17. The system of claim 14, wherein the bush of the assembly tool includes a first cylindrical section, a second cylindrical section, and a radially inwardly projecting flange positioned intermediate the first and second cylindrical sections, wherein the thread of the bush of the assembly tool is an internal thread positioned within the first cylindrical section of the bush of the assembly tool,
wherein the stem of the assembly tool includes a first end, a second end opposite the first end of the stem of the assembly tool, and a shaft extending from the first end of the stem of the assembly tool to the second end of the stem of the assembly tool, wherein the first external thread of the stem of the assembly tool is positioned on the first end of the stem of the assembly tool, wherein the second thread of the stem of the assembly tool is an external thread positioned on the second end of the stem of the assembly tool, and wherein a diameter of the second end of the stem of the assembly tool is greater than a diameter of the first end of the stem of the assembly tool,
wherein the plunger of the assembly tool includes a flange section secured within the second cylindrical section of the bush of the assembly tool in a manner such that the flange section of the plunger of the assembly tool is capable of pivoting with respect to the bush of the assembly tool about the longitudinal axis of the assembly tool but is prevented from moving axially with respect to the bush of the assembly tool along the longitudinal axis of the assembly tool, wherein the plunger of the assembly tool encompasses the shaft of the stem of the assembly tool, wherein the plunger of the assembly tool includes two oblong holes, and wherein a side of the plunger of the assembly tool facing away from the bush includes a front wall having a chamfer,
wherein a stud passes through the two oblong holes of the plunger of the assembly tool and the spacer ring of the assembly tool such that the spacer ring of the assembly tool is prevented from rotating with respect to the plunger of the assembly tool about the longitudinal axis of the assembly tool and is allowed to axially move with respect to the plunger of the assembly tool along the longitudinal axis of the assembly tool, and
wherein each of the bush of the assembly tool and the stem of the assembly tool includes gripping means for a torque transfer tool.

18. A method for mounting a thread insert in an opening of a workpiece, the method comprising the steps of:
providing an assembly tool, the assembly tool including
a stem including a first external thread extending over at least a portion of the stem and a second thread extending over at least a portion of the stem,
a bush including a thread that is engaged with the second thread of the stem,
locking means for releasable locking of a rotation of the stem relative to the bush about a longitudinal axis of the assembly tool,
a plunger supported by the bush, and
a spacer ring surrounding at least a portion of the stem and coupled to the stem,
wherein a length of the stem and a length of the bush complement one another such that the first external thread of the stem protrudes at least partially from the bush;
providing a thread insert including a bush having an exterior surface, an external thread formed in the exterior surface and complementary to the opening of the workpiece, an internal thread that is complementary to the first external thread of the stem of the assembly tool, at least one longitudinal groove in the exterior surface, and a stud positioned in each of the at least one longitudinal groove such that the stud does not extend completely along the external thread of the thread insert;
threadedly engaging the internal thread of the thread insert to the first external thread of the stem while the locking means of the assembly tool locks the rotation of the stem of the assembly tool relative to the bush of the assembly tool about the longitudinal axis of the assembly tool;
threadedly engaging the external thread of the thread insert to the opening of the workpiece by a rotation of the bush together with the stem about the longitudinal axis of the assembly tool in a first direction while the locking means of the assembly tool locks the rotation of the stem of the assembly tool relative to the bush of the assembly tool about the longitudinal axis of the assembly tool, until the assembly tool contacts the workpiece;
configuring the locking means of the assembly tool such that the locking means of the assembly tool allows rotation of the stem of the assembly tool relative to the bush of the assembly tool about the longitudinal axis of the assembly tool; and
anchoring the thread insert in the opening of the workpiece by a rotation of the bush about the longitudinal axis of the assembly tool in the first direction relative to the stem, whereby the bush and the plunger move axially relative to the stem along the longitudinal axis of the assembly tool such that the rotation of the bush in the first direction relative to the stem causes the plunger to drive the stud into the at least one groove of the thread insert.

19. The method of claim 18, further comprising the step of removing the assembly tool from the thread insert by rotating the bush about the longitudinal axis of the assembly tool in a second direction that is opposite the first direction.

20. The method of claim 18, wherein the step of threadedly engaging the external thread of the thread insert to the opening of the workpiece includes threadedly engaging the external thread of the thread insert to the opening of the workpiece by a rotation of the bush together with the stem about the longitudinal axis of the assembly tool in a first direction while the locking means of the assembly tool locks the rotation of the stem of the assembly tool relative to the bush of the assembly tool about the longitudinal axis of the assembly tool, until the spacer ring of the assembly tool contacts the workpiece.

21. The method of claim 18, wherein the assembly tool further comprises an adjusting collar adjustably connected to the spacer ring,
wherein the method further comprises the step of adjusting a position of the adjusting collar relative to the spacer ring prior to threadedly engaging the internal thread of the thread insert to the first external thread of the stem, and
wherein the step of threadedly engaging the external thread of the thread insert to the opening of the workpiece includes threadedly engaging the external thread of the thread insert to the opening of the workpiece by a rotation of the bush together with the stem about the longitudinal axis of the assembly tool in a first direction while the locking means of the assembly tool locks the rotation of the stem of the assembly tool relative to the bush of the assembly tool about the longitudinal axis of the assembly tool, until the adjusting collar of the assembly tool contacts the workpiece.
